(19) United States
(12) Patent Application Publication
(10) Pub. No.: US 2017/0072522 A1
(43) Pub. Date: Mar. 16, 2017

(54) Machining Center having Arrangement for Absorbing Thermal Expansion

(71) Applicant: Ming-Yueh Yeh, TAICHUNG CITY (TW)

(72) Inventor: Ming-Yueh Yeh, TAICHUNG CITY (TW)

(21) Appl. No.: 14/855,423

(22) Filed: Sep. 16, 2015

(51) Int. Cl. B23Q 11/00; F28F 3/00; B23Q 11/12

(52) U.S. Cl. CPC B23Q 11/0007; B23Q 11/128; F28F 3/00

(57) ABSTRACT

A machining center includes a rectangular base; two walls disposed on two sides of a top of the base respectively; two parallel rails disposed on a top of each wall, the rails extending in X-direction; two sliding members each slidably disposed on the rails on each wall; two parallel rail members disposed on a top of each sliding member, the rail members extending in Y-direction; a transverse beam having a first end secured to one sliding member and a second end slidably disposed on the other sliding member; and a sliding element slidably mounted on a front surface of the transverse beam. The second end of the transverse beam may move relative to one sliding member in response to heat buildup in the transverse beam.

### BACKGROUND OF THE INVENTION

1. Field of the Invention

The invention relates to machining centers and more particularly to a machining center having a plurality of highly conductive grooved members mounted on bottom of one end of a transverse beam so that heat generated in operation can be efficiently transferred from the transverse beam to rail members by means of the grooved members, thereby preventing the transverse beam from being adversely deformed due to thermal expansion.

2. Description of Related Art

Machining centers are classified as either vertical or horizontal. Machining centers are used for shaping or machining metal or other rigid materials, usually by cutting, boring, grinding, shearing, or other forms of deformation. Bridge type machining centers are widely used in the industry.

A conventional bridge type machining center is shown in FIG. 7 and comprises a rectangular base 90, two walls 91 on both sides of a top of the base 90; two parallel rails (not numbered) on a top of each wall 91; a transverse beam 92 having two ends slidably seated on the rails; and a sliding element 93 slidably mounted on a front surface of the transverse beam 90.

One drawback of the conventional bridge type machining center is that the transverse beam 90 may significantly deform due to thermal expansion in operation. And in turn, it may greatly decrease precision of a product being machined by the conventional bridge type machining center.

Thus, the need for improvement still exists.

### SUMMARY OF THE INVENTION

It is therefore one object of the invention to provide a machining center comprising a rectangular base; two walls disposed on two sides of a top of the base respectively; two parallel rails disposed on a top of each wall, the rails extending in X-direction; two sliding members each slidably disposed on the rails on each wall; two parallel rail members disposed on a top of each sliding member, the rail members extending in Y-direction; a transverse beam having a first end secured to one sliding member and a second end slidably disposed on the other sliding member; and a sliding element slidably mounted on a front surface of the transverse beam; wherein the second end of the transverse beam is configured to move relative to one sliding member in response to heat buildup in the transverse beam.

The above and other objects, features and advantages of the invention will become apparent from the following detailed description taken with the accompanying drawings.

### BRIEF DESCRIPTION OF THE DRAWINGS

FIG. 1 is a perspective view of a bridge type machining center according to the invention;

FIG. 2 is an exploded view of the machining center;

FIG. 3 is an exploded view showing the grooved members to be mounted between the bottom of the transverse beam and the rail members on top of one sliding member;

FIG. 4 is a perspective view showing the mounted grooved members to be further mounted on the rail members;

FIG. 5 is a top view showing the sliding movements of the transverse beam by means of moving the sliding members along the rails;

FIG. 6 is an enlarged view of the central portion of FIG. 5 showing the sliding movements of one end of the transverse beam by means of moving the grooved members along the rail members; and

FIG. 7 is a top view showing the sliding movements of a transverse beams of a conventional machining center by means of moving along rails on a top of each wall.

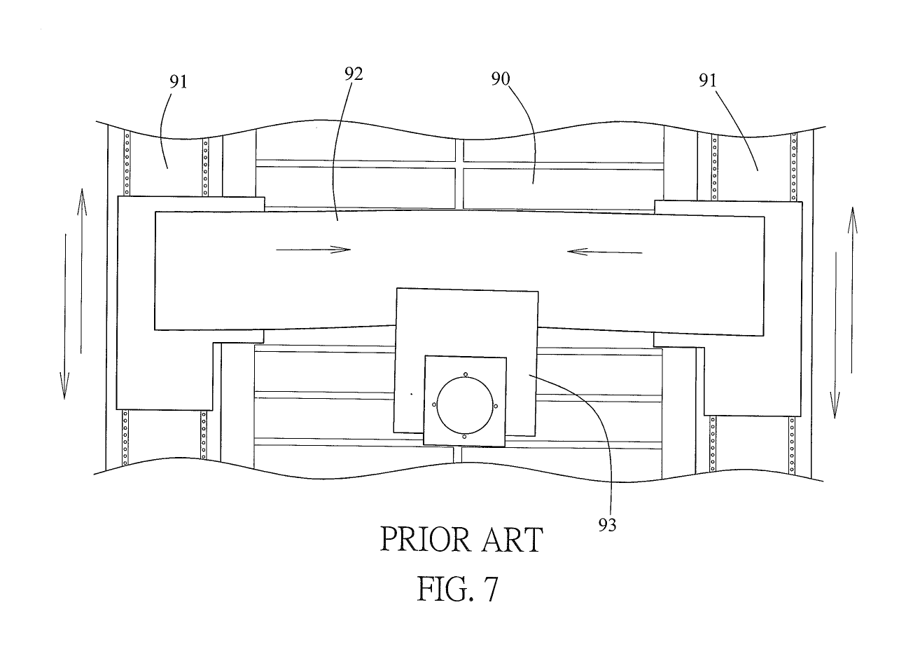

### DETAILED DESCRIPTION OF THE INVENTION

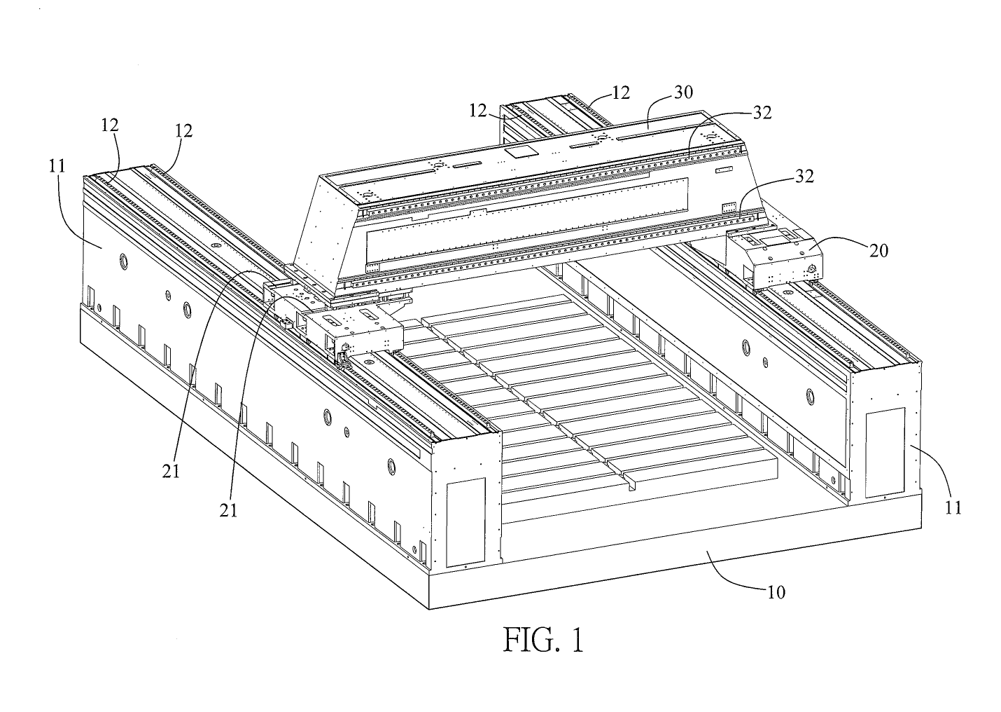

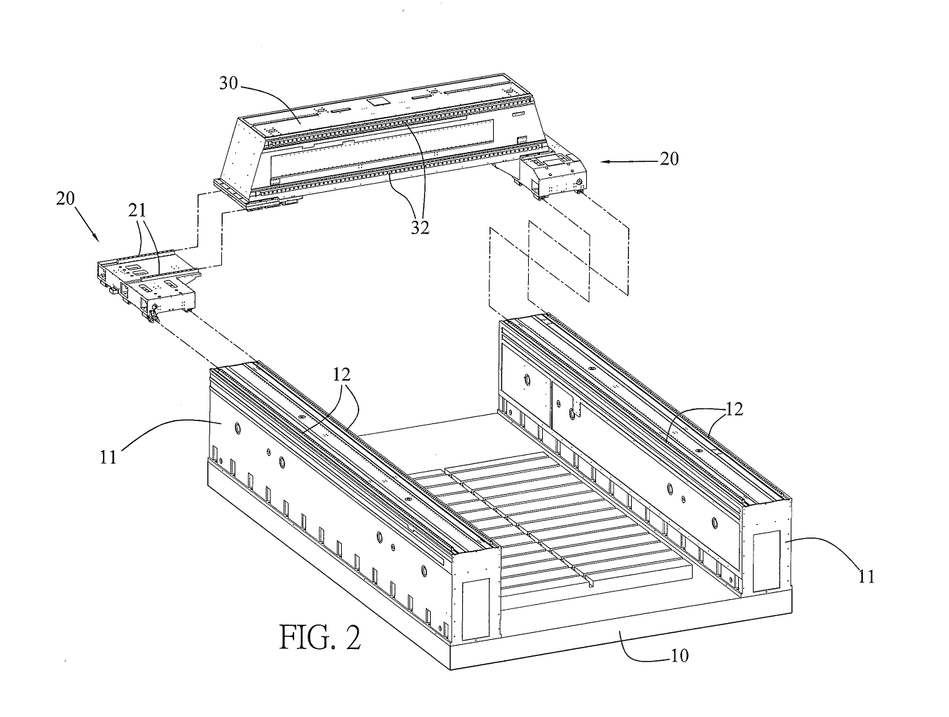

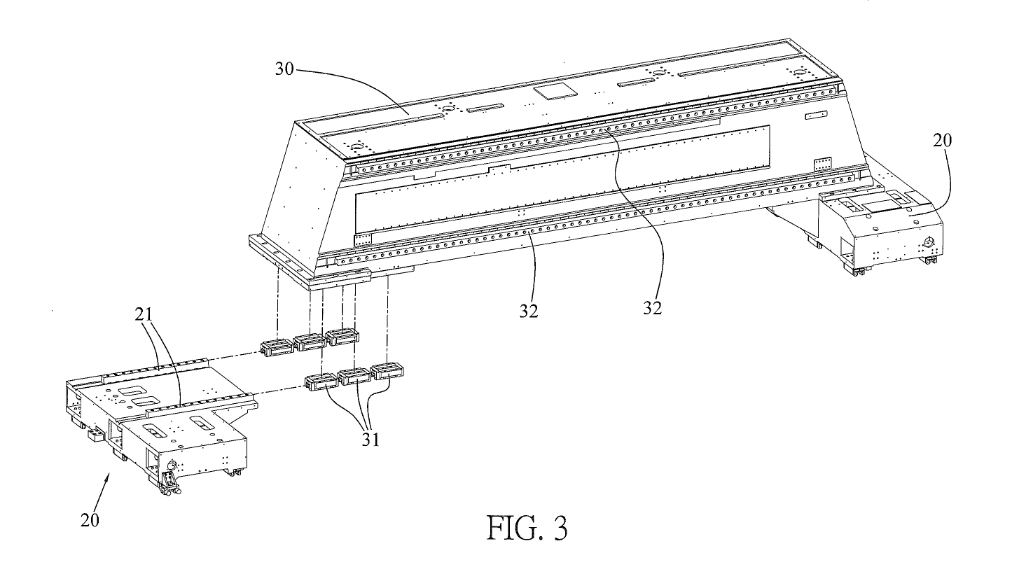

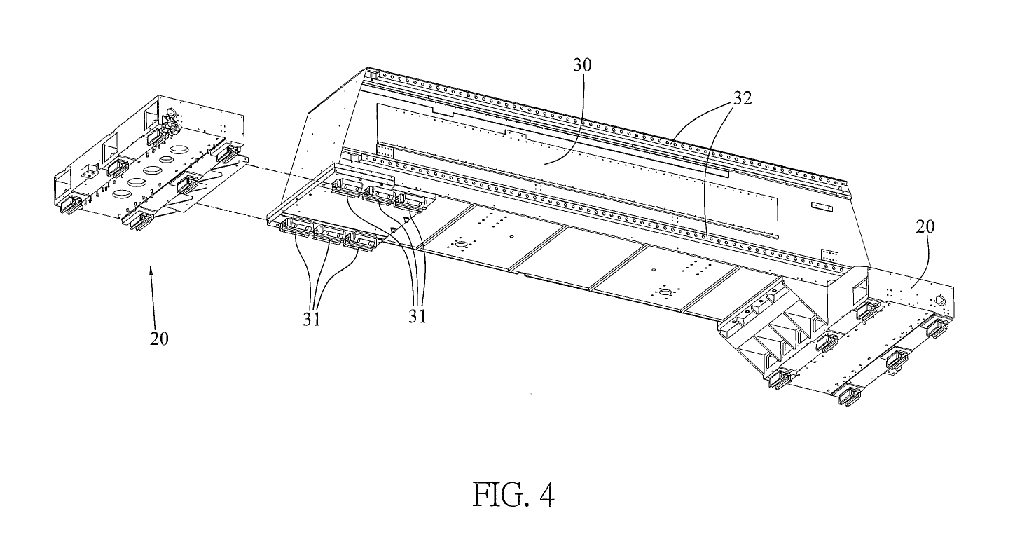

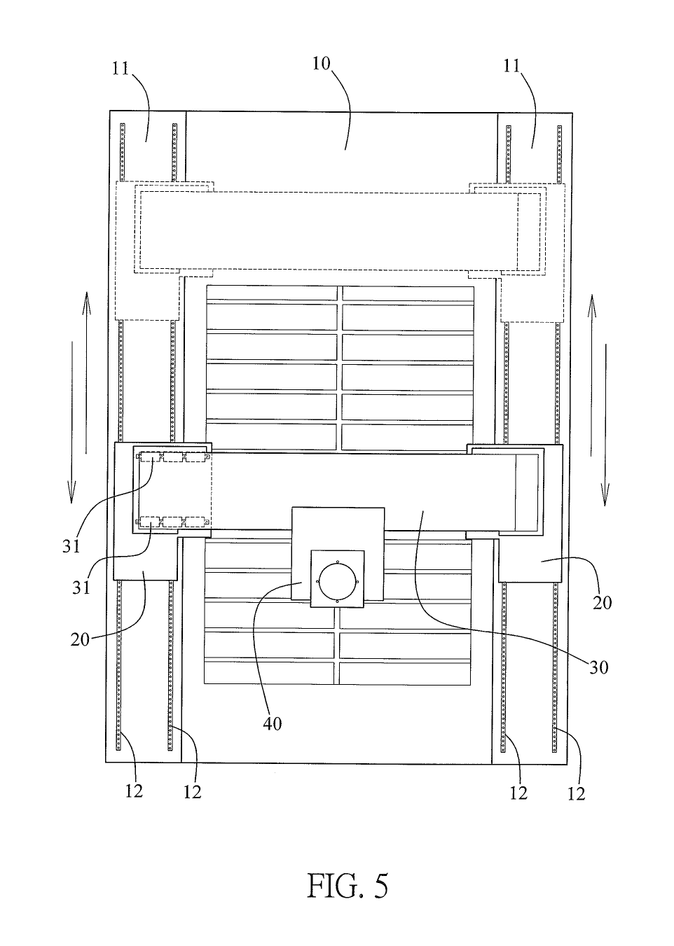

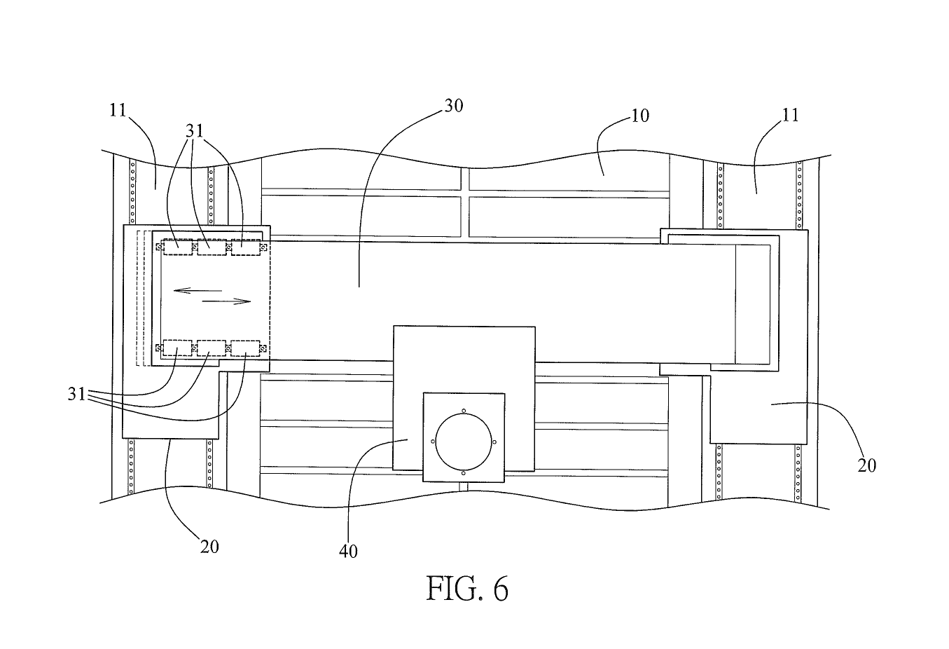

Referring to FIGS. 1 to 6, a machining center in accordance with the invention comprises a rectangular base 10; two walls 11 on both sides of a top of the base 10 respectively; two parallel rails 12 on a top of each wall 11, the rails 12 extending in X-direction; two sliding members 20 each slidably disposed on the rails 12 on each wall 11; two parallel rail members 21 on a top of each sliding member 20, the rail members 21 extending in Y-direction; a transverse beam 30 including two parallel sets of a plurality of grooved members 31 on a bottom of one end, the grooved members 31 being slidably seated on the rail members 21, the grooved members 31 being adapted to efficiently transfer heat from the transverse beam 30 to the rail members 21, and two parallel rail elements 32 on a front surface, and a sliding element 40 slidably mounted on the rail elements 32.

In addition to moving along the rail elements 32 in Y-direction, the sliding element 40 is adapted to move in Z-direction for adjustment purpose.

In response to heat buildup in the transverse beam 30 in operation, the transverse beam 30 may transfer a substantial portion of heat to the grooved members 31 which in turn expand along the rail members 21 by absorbing the thermal expansion in the transverse beam 30, thereby preventing the transverse beam 30 from being deformed adversely.

While the invention has been described in terms of preferred embodiments, those skilled in the art will recognize that the invention can be practiced with modifications within the spirit and scope of the appended claims.

What is claimed is:

1. A machining center comprising:
a rectangular base;
two walls disposed on two sides of a top of the base respectively;
two parallel rails disposed on a top of each wall, the rails extending in X-direction;
two sliding members each slidably disposed on the rails on each wall;
two parallel rail members disposed on a top of each sliding member, the rail members extending in Y-direction;
a transverse beam having a first end secured to one sliding member and a second end slidably disposed on the other sliding member; and
a sliding element slidably mounted on a front surface of the transverse beam;
wherein the second end of the transverse beam is configured to move relative to one sliding member in response to heat buildup in the transverse beam.

2. The machining center of claim 1, wherein the transverse beam includes two parallel sets of at least one grooved member on a bottom of the first end, the parallel set of at least one grooved member being slidably seated on the rail members.

3. The machining center of claim 1, wherein the transverse beam includes two parallel rail elements on the front surface, the sliding element being slidably disposed on the rail elements.
